(19) United States
(12) Patent Application Publication
(10) Pub. No.: US 2005/0139448 A1
(43) Pub. Date: Jun. 30, 2005

(54) Coin distributor

(75) Inventor: Roland Griese, Berlin (DE)

Correspondence Address: WILLIAM M HANLON, JR;YOUNG & BASILE, PC, 3001 WEST BIG BEAVER ROAD, SUITE 624, TROY, MI, 48084-3107, US

(73) Assignee: Walter Hanke Mechanische Werkstatten Gmbh & CO., KG, Berlin (DE)

(21) Appl. No.: 10/508,772

(22) PCT Filed: Mar. 18, 2003
(86) PCT No.: PCT/EP03/02806

(30) Foreign Application Priority Data
Mar. 28, 2002 (DE) 102 15 467.8

(51) Int. Cl. G07F 1/04

(52) U.S. Cl. 194/346

(57) ABSTRACT

The invention relates to a coin distributor, containing a deflection unit comprising a displaceable deflection member for sorting coins into different coin slots or similar. The distributor is provided with at least one device for detecting the passage of a coin through a coin slot, said device comprising at least one emitter, a beam switcher, in addition to a beam receiver. The beam switcher is fixed to the displaceable deflection member.

### BACKGROUND OF THE INVENTION

The present application relates to a coin distributor for coin-operated equipment such as coin checkers for example, in accordance with the preamble of claim 1.

Usually, in an electronic coin checker, the examined coin is guided by a coin distributor either into one or more acceptance shafts or even into a return shaft, in dependence on whether certain acceptance criteria are met. This occurs via deflection units, such as flaps for example, which are driven by electromagnets. Generally there is arranged in the acceptance shaft below the deflection unit a device for detecting the passage of a coin through a coin shaft, e.g. a light barrier, which checks the presence of the accepted coin and sends a corresponding signal to a connected evaluation unit if a coin has passed into the light barrier or respectively out again. When the coin enters the light barrier, the evaluation unit interrupts the triggering of the electromagnet, such that the deflection unit (e.g. flap) assumes its rest position again and, when the coin exits from the light barrier, generates the credit signal.

In coin-operated machines which have a coin distributor according to the preamble, attempts are repeatedly made to achieve credit signals fraudulently by the coins being suspended on threads and these coins then being withdrawn again after they have been dipped into the light barrier. If the coin, when it is dipped into the light barrier, is still located in the region of the flap, such a manipulation is easily possible since the flap is prevented by the coin from reaching its rest position. The way back is therefore kept open by the coin itself hanging on the thread.

One solution to this problem consists in arranging the light barrier so far below the flap that the latter can reach its rest position again when the coin dips into the light barrier (because the light barrier lies more than the diameter of a coin below the flap). Withdrawing the coin is then reliably prevented by the closed flap.

However, often the space available below the flap is not sufficient to thus achieve the necessary spacing between the deflection unit (flap) and the device for detecting the passage of a coin (in the light barrier of the prior art). For this purpose there is a known way of providing a light barrier arrangement with which the direction in which the coin dips into the light barrier and leaves it again can also be determined. This is possible for example by means of two light barriers arranged the one behind the other. In this way, however, the problem of a lack of installation space is possibly made even greater such that the expert is in practice often obliged, in order to optimise installation space, to make concessions to safety requirements.

The document U.S. Pat. No. 5,485,906 shows a coin distributor of this type. It contains on the one hand a displaceable deflection member for sorting coins into different coin shafts. Moreover a device is shown for detecting the passage of a coin through a coin shaft, this device including at least one emitter, a beam switcher and a beam receiver. This beam switcher is secured to a different flap from the deflection member, it being intended primarily that manipulation by withdrawing an inserted coin using a thread should be prevented with the aid of this flap. This document according to the prior art thus shows a device which is mechanically relatively extravagant and large-scale.

The object underlying the present invention, therefore, is to create a coin distributor to be fitted into coin checkers, which coin distributor can offer the highest possible amount of security with the smallest requirements in installation space.

This object is accomplished by a coin distributor according to the present invention.

Because in a coin distributor according to the preamble, the beam switcher of the device for detecting the passage of a coin through a coin shaft is secured to the displaceable deflection member of the deflection unit for sorting coins into different coin shafts or the like, the installation space is minimised.

This opens up completely new constructional possibilities. Since the beam switcher is generally a passive element, a power supply or the like, which would be expensive to construct, is not necessary. On the other hand this also makes it possible to accommodate a device for detecting the passage of a coin, e.g. a light barrier, directly at the level of the displaceable deflection member. This opens up the possibility, even in the case of small-scale coin distributors, of also accommodating inside the coin distributor a second device for detecting the passage of a coin, without there being too large installation space requirements.

Advantageous developments of the present invention are quoted hereinafter.

### SUMMARY OF THE INVENTION

A particularly advantageous development provides for a first and a second device for detecting the passage of a coin, the direction of a coin along a coin path in at least one coin shaft being capable of being detected from the signals of the beam receivers. Here the first device is disposed on the displaceable deflection member and the second device is arranged upstream or downstream in respect of the coin path. It is advantageous to accommodate the second device downstream (i.e. generally below the first device), since in this way a manipulation from outside is made more difficult in that the second light barrier is protected by the displaceable deflection member.

In particular in this variant having two devices for detecting the passage of a coin (as well as the direction), the present invention is useful since it makes it possible to provide two devices directly in the region of the deflection unit. Here the spacing of these devices is also no longer dependent on the size of the deflection unit; it is no longer necessary e.g. to attach one device for detecting the passage of a coin above the deflection unit and one device below the deflection unit (the disadvantage of this is that the spacing between the two devices would then possibly be more than the diameter of one coin, and this would lead to additional manipulation or error possibilities: if two coins run behind one another through the same coin shaft in too quick succession, a reversal of direction of a single coin could be falsely assumed in this case although in reality two coins were involved).

A further advantageous development provides for the device for detecting the passage of a coin to be designed as an arrangement of light barriers. Here the emitter is preferably designed as an infrared light-emitting diode and the beam receiver as an infrared light receiver. The beam switcher is to be designed either as a mirror which deflects singly or multiply, or as a singly, preferably however multiply deflecting prism (e.g. deflecting twice with a total angle of 180°). Additional types of radiation can moreover be utilised as the radiation, e.g. visible light, laser light, ultraviolet light.

A particularly advantageous development provides for the displaceable deflection member to be a deflection device which can be displaced in translation or a pivotable flap. Mirrors or prisms can easily be arranged in both deflection members.

Here a particularly advantageous embodiment provides for the beam switcher integrated into the deflection device or the flap to be so designed that, when the coin shaft is not blocked by a coin or the like and the radiant power of the emitter remains the same, the quantity of radiation received by the beam receiver remains substantially the same:

This is relatively easy to achieve with a deflection device which is displaceable in translation, by the beam direction representing the same direction as the translational direction of motion of the deflection device.

In the case of a pivotable flap, an additional curvature optical system can possibly also be provided which ensures that in the different angular positions of the pivotable flap the same radiant power or quantity of radiation of the emitter reaches the radiation receiver.

### BRIEF DESCRIPTION OF THE DRAWINGS

The invention is now explained with the aid of a number of figures. These show:

FIGS. 1a and 1b: a number of views of a device for detecting the passage of a coin through a coin shaft,

FIGS. 2a and 2b: a coin distributor according to the invention, respectively with or without a coin,

FIG. 3: the coin distributor according to the invention in a reduced view.

### DETAILED DESCRIPTION OF THE PREFERRED EMBODIMENT

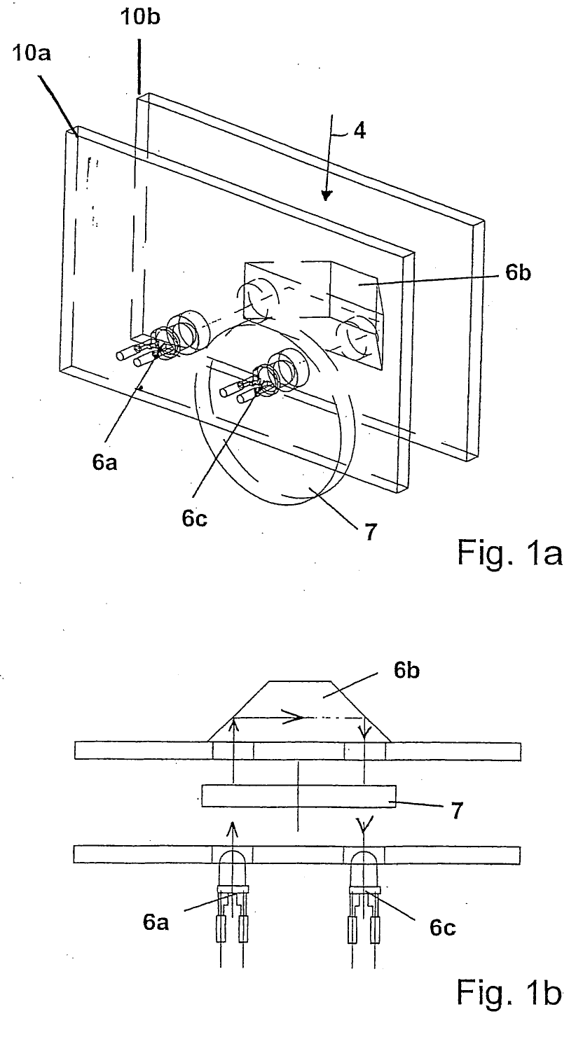

FIG. 1a shows a device for detecting the passage of a coin through a coin shaft. This has an emitter 6a in the form of an infrared light-emitting diode. The light going out from the infrared light-emitting diode 6a passes corresponding openings of two boundary walls 10a or 10b of a coin shaft. On the side of the boundary wall 10b remote from the light-emitting diode 6a is attached a doubly deflecting prism 6b. This prism 6b deflects the light going out from the light-emitting diode 6a by 180° altogether and sends it through two corresponding openings in the boundary walls 10b and 10a to a beam receiver 6c.

The exact course of the light radiation can be seen indicated by arrows in FIG. 1b. Also in FIGS. 1a and 1b can be recognised a coin 7 which runs through a coin shaft 4 and in so doing interrupts the beam proceeding from the emitter 6a. In this way, the beam receiver 6c briefly does not receive any radiation and this is passed on to a connected evaluation unit as a “credit signal.”

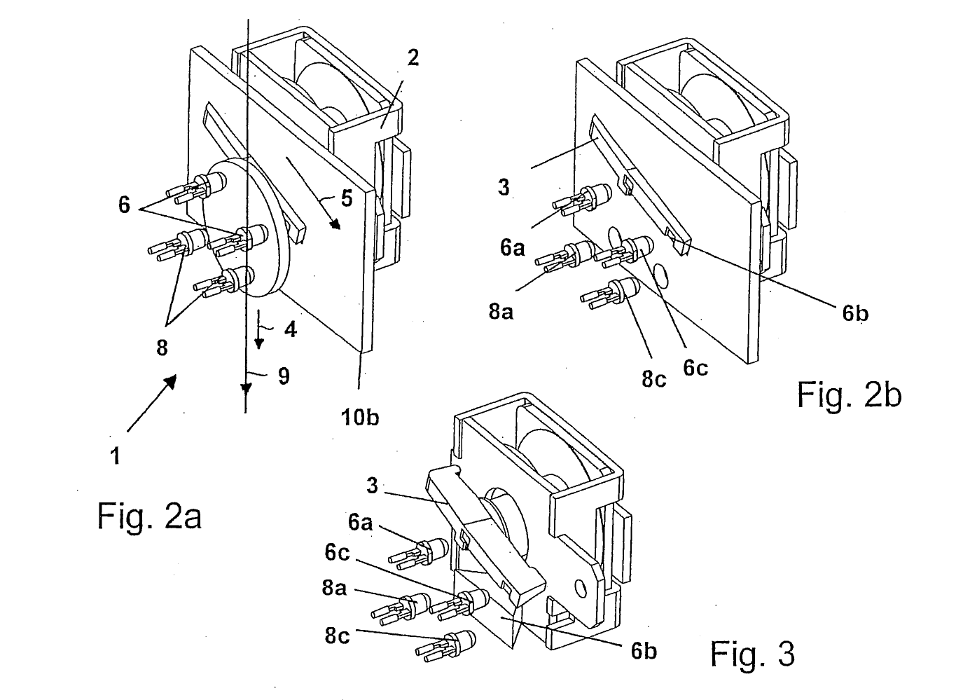

FIGS. 2a and 2b show a coin distributor according to the invention. The only difference between these drawings consists in the fact that in FIG. 2a a passing coin 7 is also shown.

FIGS. 2a and 2b show a coin distributor 1 containing a deflection unit 2. This deflection unit is attached to the rear side of a boundary wall 10b. The boundary wall 10b has a slit-shaped opening in which a displaceable deflection member engages, here a deflection device 3 which can be displaced in translation. The deflection unit 2 contains an electromagnet, according to which the deflection device 3 lies substantially flush with the boundary wall 10b or protrudes from same. According to the position of the deflection device, a coin 7 is guided into a different coin shaft, i.e. it runs along a different path. In the position shown in FIG. 2a, the coin runs along coin path 9, i.e. coin shaft 4, since the deflection device 3 lies substantially flush with the boundary wall 10b. In the event of the deflection device 3 protruding a long way from the boundary wall 10b and thus blocking the coin path 9, the coin 7 would be stopped by the deflection device and would run on in the direction of coin shaft 5.

Here coin shaft 4 is the so-called “acceptance channel”, i.e. the shaft for coins to be accepted for which a credit signal is to be emitted. Coins which are not accepted are passed on to coin shaft 5.

The so-called credit signal is registered on the basis of a device for detecting the passage of a coin through a coin shaft. This device is explained below with the aid of FIG. 2b for reasons of clarity. A device for detecting the passage of a coin comprises the elements already shown in FIGS. 1a and 1b, emitter 6a, beam switcher 6b and beam receiver 6c, such that here reference is made completely to the above description. The single difference from FIG. 1a consists in the fact that the biprismatic beam switcher 6b is not arranged fixed inside a wall but inside the deflection device 3. To guide radiation in or out, the deflection device 3 has two openings which align with the emitter 6a or respectively with the beam receiver 6c.

It is essential that the beam switcher, here the biprism 6b, is secured to the displaceable member, here the deflection device 3. By this means, the above-described advantages of the invention relating to small installation space are exploited. It must also be noted that the beam switcher 6b is so designed that, when the coin shaft 4 is not blocked by a coin 7 and the radiant power of the emitter 6a remains the same, the quantity of radiation received by the beam receiver 6b remains substantially the same. The reason for this is that the translational movement of the deflection device 3 (due to the electromagnet) is in line with the emitter 6a or respectively the beam receiver 6c as well as the radiation emitted or received by same. The radiation is so bundled in the beam control that the alteration in spacing (depending on whether the deflection device 3 is flush with the wall 10b or not) has practically no influence on the quantity of radiation arriving at the beam receiver.

Alternatively, other displaceable deflection members are obviously possible, for example pivotable flaps. As the beam switcher can here be used (just as in the above deflection unit) also single or multiple mirrors or prisms. In the case of a pivotable flap, a curvature optical system is to be provided if necessary in order to make the light intensity arriving at the beam receiver the same, independently of the position of the flap.

In order to avoid the “thread tricks” described initially, in each of FIGS. 2a and 2b are shown two devices for detecting the passage of a coin. These are first of all a first device 6 (having components 6a, 6b, 6c) and a corresponding second device 8, comprising identical components 8a, 8b, 8c. The structure of the second device 8, especially of the biprism 8b, can be recognised particularly well in FIG. 3.

Because the second device 8 lies below, (i.e. downstream relative to the coin path 9 in coin shaft 4) this device is protected by the deflection device 3 when the latter is not flush with the wall 10b. Both device 6 and device 8 (especially the beam receivers 6c or 8c) are connected to an evaluation unit which is not shown. If a coin checker is arranged above the deflection device 3 to verify suitable coins, the deflection device 3 travels back into the substantially flush position relative to the boundary wall 10b, such that a coin 7 can run through coin shaft 4 along coin path 9. In this process the evaluation unit initially receives an interrupt signal from beam receiver 6c and then from beam receiver 8c. From this sequence, the direction of the coin can be clearly derived (i.e. its correct passage). According to this, on the basis of the evaluation unit, which is also connected to the electromagnet for driving the deflection device, the deflection device is moved back into the position where it is not flush with the boundary wall 10b, so that it is not possible to withdraw a coin which is selected with the credit signal. For particularly fault-free functioning of the arrangement shown in FIGS. 2a to 3, it is advantageous if the spacing between beam receiver 6c and beam receiver 8c in the direction of the coin path 9 is less than the diameter of the smallest valid coin, since in this way malfunctions due to a plurality of small coins falling through in quick succession can be prevented.

1. Coin distributor containing a deflection unit which has a moveable deflection member for sorting coins into different coin shafts, and at least one device for detecting the passage of a coin through a coin shaft, this device including at least one emitter, a beam deflector and a beam receiver, characterised in that the beam deflector is secured to the moveable deflection member.

2. Coin distributor according to claim 1, characterised in that a first and a second device for detecting the passage of a coin are provided, the direction of a coin along a coin path in at least one coin shaft being capable of being detected from the signals of the beam receivers.

3. Coin distributor according to claim 2, characterised in that the first device for detecting the passage of a coin is arranged on the moveable deflection member and the second device is arranged downstream or upstream in respect of the coin path.

4. Coin distributor according to claim 1, characterised in that the emitter is an infrared light-emitting diode.

5. Coin distributor according to claim 1, characterised in that the beam deflector is a one of a mirror and prism which deflects singly or multiply.

6. Coin distributor according to claim 1, characterised in that the beam receiver is an infrared light receiver.

7. Coin distributor according to claim 1, characterised in that the coin shafts are at least one of a return shaft and one or more acceptance shafts.

8. Coin distributor according to claim 1, characterised in that the moveable deflection one of a deflection device which can be displaced in translation and a pivotable flap.

9. Coin distributor according to claim 1, characterised in that the beam deflector is so designed that, when coin shaft is not blocked by a coin and the radiant power of the emitter remains the same, the quantity of radiation received by the beam receiver remains substantially the same.
